(19) United States
(12) Patent Application Publication
(10) Pub. No.: US 2020/0267918 A1
(43) Pub. Date: Aug. 27, 2020

(54) METHOD AND SYSTEM FOR CAPABLE OF SELECTING OPTIMAL PLANT CULTIVATION METHOD

(71) Applicant: LAND GREEN AND TECHNOLOGY CO., LTD., Taipei City (TW)

(72) Inventor: LID FU, Taipei City (TW)

(21) Appl. No.: 16/867,544

(22) Filed: May 5, 2020

Related U.S. Application Data
(63) Continuation-in-part of application No. 15/351,447, filed on Nov. 15, 2016.

(51) Int. Cl. A01G 31/02; A01G 25/02; C02F 1/00; C02F 1/461; C02F 1/48; C02F 1/78

(52) U.S. Cl. CPC A01G 31/02; A01G 25/023; C02F 1/78; C02F 1/461; C02F 1/48; C02F 1/001

(57) ABSTRACT

A plant growing system includes a growth medium preparation unit and a plant growing unit. The growth medium preparation unit includes a supply of water that feeds water through a water treatment unit, a nutrition module, and a reactor sub-system to have the water treated and modified and added with nano-elements and other nutrition components to provide a nutrition formula. The nutrition formula is supplied to the plant growing unit that includes a growing box inside which a tank is provided for receiving and holding the nutrition formula. A plant plate is disposed on the tank and is formed with at least one through opening for receiving and holding a plant. The root of plant is allowed to extend into the nutrition formula inside the tank, while the stein of the plant is growing in a void space above the plant plate and inside the growing box.

### CROSS REFERENCE TO RELATED APPLICATIONS

This is a continuation-in-part of co-pending U.S. patent application Ser. No. 15/351,447 filed on Nov. 15, 2016.

### TECHNICAL FIELD OF THE INVENTION

The present invention relates to plant cultivation, and more particularly to a method and a system that enable selection of an optimal plant cultivation method.

### DESCRIPTION OF THE PRIOR ART

Nowadays there is a problem of food in the world. Insufficient and inadequate diet of a significant part of the world's population has a huge impact on the biological and social aspects of all mankind reproduction.

Millions of people continue to die because of hunger, malnutrition, disease, or of causes related to poor-quality food. For the same reason of poor-quality food, there are growing numbers of different diseases every year including cancers. The sources of such food in many cases are plants. Therefore, to find new, optimal ways to increase productivity and usefulness of plants is getting increasingly important.

While some countries spend big money on researches of new ways to increase the productivity and quality of plants, and at the same time, many people invest their own funds to the different studies, no method or platform is available for selection of an optimal plant cultivation process.

### SUMMARY OF THE INVENTION

An object of the present invention is to provide a system that enables selection of an optimal plant cultivation process.

To achieve the object mentioned above, the present invention provides a system that includes a plurality of water supply units, a water treatment unit, a plurality of nutrition units, a reactor, a plurality of gas supply units, a liquid storage unit, at least three growth boxes, an information device, where the plurality of water supply units are used to accommodate a plurality of water sources, the water treatment unit is connected to the water supply units and adapted to filter, purify and modify the water sources, the plurality of nutrition units are used to accommodate nutrition, each nutrient unit is delivered to a mixing device by means of a conveying device, where the mixing device is in connection with the water treatment unit and adapted to mix with the filtered water and nutrition to become nutrition solution; the reactor is in connection with the water treatment unit and mixing device, and adapted to prepare predetermined qualities of nutrition solutions by means of different control actions; the plurality of gas supply units are adapted to accommodate a plurality of gases and supply the gases to the reactor to mix with the filtered, purified and modified water and the nutrition solutions to prepare a nutrition formula for plant roots or stems; the liquid storage unit is in connection with the reactor and water treatment unit, and used to store the nutrition formula and filtered, purified and modified water; each of the at least three growth boxes is used to accommodate plants and in connection with the gas supply units and liquid storage unit, and includes a plurality of controlling elements and a cultivation unit, where the controlling elements are used to control the growth conditions of the plants and the cultivation unit is used to switch selectively among an aeroponic module, drip irrigation module and hydroponic module; the information device is in connection with a servo control unit in a stationary connection or wireless transmission way, and used to control the control actions of the reactor and the operations of the controlling elements of the growth box through the commands of the servo control unit.

Another object of the present invention is to provide a method capable of selecting an optimal plant cultivation method.

To achieve the object mentioned above, the method of the present invention includes:

(a) providing a plurality of participants with a cultivation system capable of selecting an optimal cultivation method for carrying out a plant cultivation competition;

(b) establishing the eligibility of the plant cultivation competition;

(c) establishing a growing method in the plant cultivation competition, the growing method being aeroponics, drip irrigation or hydroponics;

(d) establishing types of plants in the plant cultivation competition; € combining the growing methods with the plant types so as to carry out a variety of plant cultivation competitions, the participants choose the growing methods and plant types;

(f) announcing competition starting date and participants registration period through media, all participants finish registration process and pay an access fee on the website;

(g) giving all participants required seedlings and one incubator containing at least three growing boxes; allowing participants to cultivate seedlings with three different conditions or using three different growth formulas at the same time, which gives more chances to succeed;

(h) adjusting and controlling plant growing conditions, growing methods and nutrition formula in the growth boxes by the participants by selecting a plurality of controlling elements, cultivation units and reactor provided by the plant cultivation system of the optimal plant cultivation method;

(i) choosing the best one growing box out of three and submitting it to selection committee by participants after the competition finishes, the committee selecting the best growing method and nutrition formula, thereby finding out the best cultivation methods of the plants; and

(j) selecting the best plant cultivation method according to the types of the plants, and judging and rating the specifications of the types of the plants.

### BRIEF DESCRIPTION OF THE DRAWINGS

FIG. 1 is a schematic view of a system of a first preferred embodiment according to the present invention;

FIG. 2 is a schematic view of water supply units and water treatment unit of the present invention;

FIG. 3 is a schematic view of a nutrition unit of the present invention;

FIG. 4 is a schematic view of a reactor of the present invention;

FIG. 5 is a schematic view of gas supply units of the present invention;

FIG. 6 is a schematic view of growth boxes of the present invention; and

FIG. 7 is a system view of a second preferred embodiment of the present invention.

FIG. 8 is a schematic view showing a plant growing system that functions as a smart plant factory according to a different embodiment of the present invention.

FIG. 9 is an exploded view showing a growing box, which functions as a phytotron for growing one or more plants therein, incorporated in the plant growing system according the present invention, wherein a one-piece plant plate is used to hold plants in the growing box.

FIG. 10 is an exploded view of the growing box taken from a different angle, with upper and lower tanks and a plant plate removed for simplification.

FIG. 11 is a perspective view showing the upper and lower tanks of the growing box of the plant growing system according to the present invention, the tanks being arranged in a stacked form, a modified example of two separate plant plates arranged side by side being disposed atop the stack.

FIG. 12 is a perspective view showing the lower tank of the growing box of the plant growing system.

FIG. 13 is perspective view showing the stack of upper and lower tanks taken from a different angle, one of the two plant plates being shown in a see-through manner to illustrate inside details of the upper tank, in which at least one partition is mounted to divide an interior space of the upper tank into multiple compartments.

FIG. 14 is a perspective view showing the growing box of a modified form according to the present invention, the growing box being shown in a closed condition.

FIG. 15 is a perspective view, similar to FIG. 14, but showing the growing box in an opened condition.

FIG. 16 is a perspective view showing an additional form of the growing box according to the present invention, with the glass plate and the corner removed from the top of the box body for illustration of the inside details, various devices, including a fan, an LED light, and a ventilator, being mounted to sidewalls of the box body.

### DETAILED DESCRIPTION OF THE PREFERRED EMBODIMENT

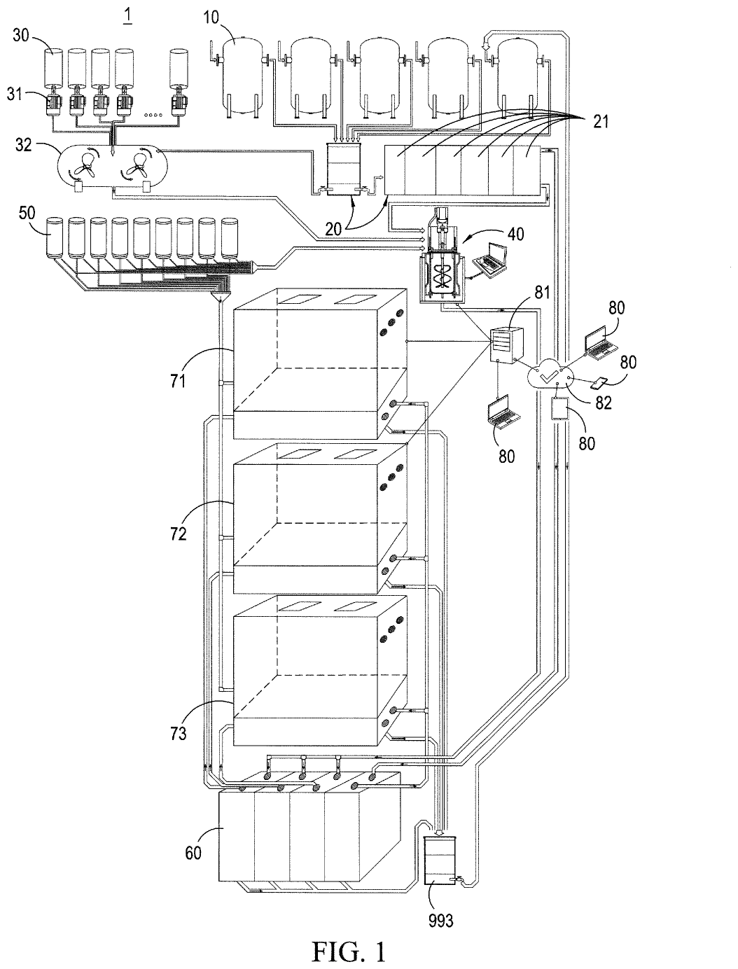

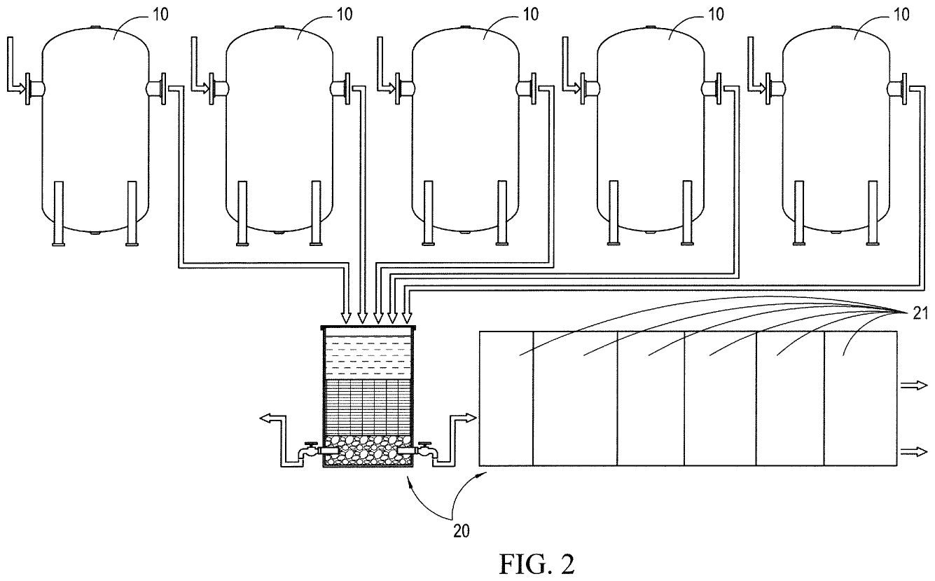

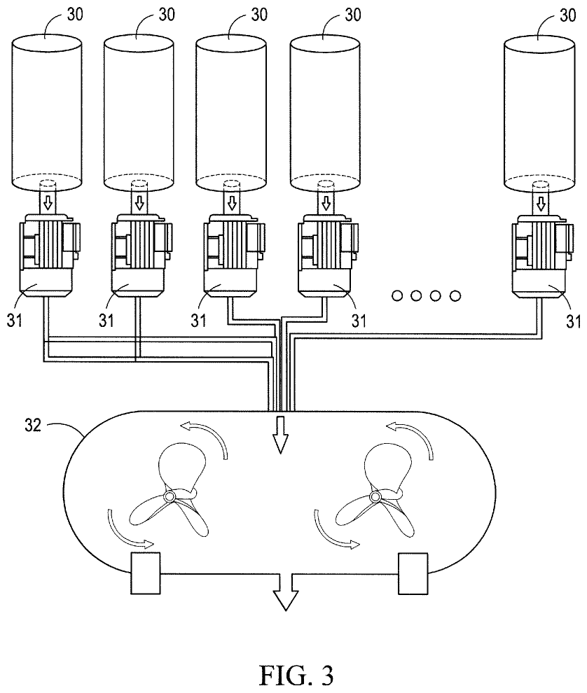

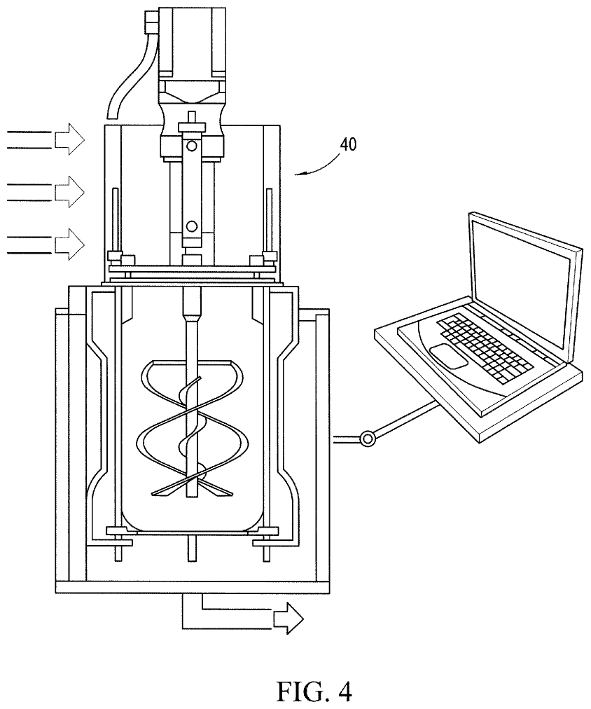

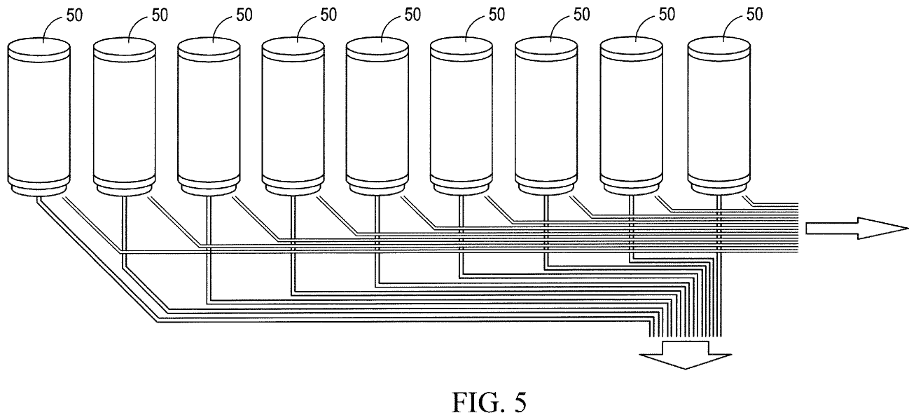

Referring to FIGS. 1-6, a plant cultivation system 1 according to the present invention is provided for selection of an optimal plant cultivation process. The system 1 comprises a plurality of water supply units 10, a water treatment unit 20, a plurality of nutrition units 30, a reactor 40, a plurality of gas supply units 50, a liquid storage unit 60, at least three growth boxes 71, 72, 73, and an information device 80.

The plurality of water supply units 10 receive and hold therein a plurality of different water sources, respectively.

The water treatment unit 20 is connected to the plurality of water supply units 10 to carry out treatment on the plurality of different water sources of the plurality of water supply units through various operations, including filtering, purifying, and modifying the water sources in order to supply filtered, purified and modified water.

The plurality of nutrition units 30 receive and hold therein nutrition elements. Each of the plurality of nutrient units 30 supplies the nutrition element held therein to a mixing device 32 through a conveying device 31 connected to the nutrient unit 30. The mixing device 32 is in connection with the water treatment unit 20 to selectively mix the filtered, purified and modified water with the nutrition elements from the nutrient units 30 to make a nutrition solution.

The reactor 40 is in connection with the water treatment unit 20 and is operable to prepare predetermined qualities of nutrition solutions by means of different control actions.

The control actions of the reactor 40 include a mixing function, a mixing speed control function, a temperature control function with heating and cooling operations, an electrical conductivity control and change function, PH control, a particle size control function, a function of automatic feed of solution to a tank section (nutrient solution storage) of an incubator, and may have other functions on user demand.

The plurality of gas supply units 50 receive and hold therein a plurality of kinds of gases, respectively, and supply the gases to the reactor 40 to mix with the filtered, purified and modified water from water treatment unit 20 and the nutrition solution to prepare a nutrition formula for plant roots or stems.

The liquid storage unit 60 is in connection with the reactor 40 and the water treatment unit 20 and stores the nutrition formula and the filtered, purified and modified water.

Each of the at least three growth boxes 71, 72, 73 is structured to accommodate the same kind (or different kinds) of plant and is in connection with the gas supply units 50 and the liquid storage unit 60 to receive the gases, the nutrition formula and the filtered, purified and modified water and includes a plurality of controlling elements and a cultivation unit. The controlling elements are used to control a growth condition of the plant and the cultivation unit is operable to switch selectively among an aeroponic module 741, a drip irrigation module 742, and a hydroponic module 743.

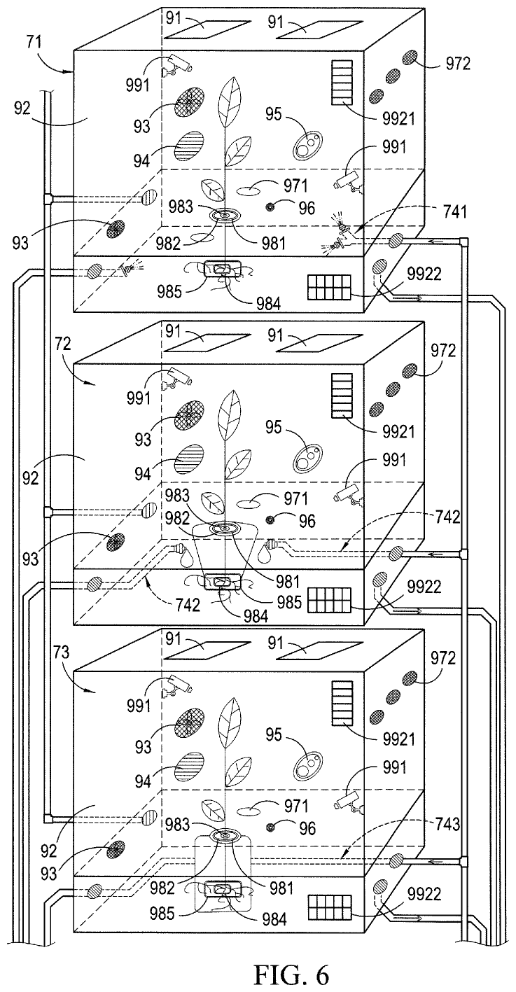

In an example shown in FIG. 6, the growth box 71 is switched to an aeroponic module; the growth box 72 is switched to a drip irrigation module 742, and the growth box 73 is switched to a hydroponic module 743. However, a user may selectively switch each of the growth boxes 71, 72, 73 among the aeroponic module 741, the drip irrigation module 742, and the hydroponic module 743 as desired. For example, in a competition of plant cultivation, a user who holds the control of for example the growth box 71 may set, by means of the information device 80 to be further discussed below, the growth box 71 as an aeroponic module 741 in accordance with the provisions of the competition.

The information device 80 is in connection with a servo control unit 81 that is in connection with the reactor 40 by means of wired connection or wireless transmission to control the control actions of the reactor 40 and the operations of the controlling elements of the growth boxes 71, 72, 73 through the servo control unit 81.

In the example shown in FIG. 1, the information device 80 is set in connection with the servo control unit 81 through a network 82, such as the Internet.

The information device 80 may be a notebook computer, a mobile phone, a tablet computer, or the likes.

In an embodiment, the plurality of water supply units 10 comprise five (5) water supply units that respectively receive and hold rainwater, tap water, distilled water, aquaponics system water and other water.

In an embodiment, the water treatment unit 20 includes a plurality of water treatment means 21, such as six (6) water treatment means, in which ozone (O₃), water magnetization, ultraviolet (UV) light, electrolysis of water, low frequency sounds, and other possible treatments means are respectively applied to treat water flowing therethrough. Preferably, separate channels are provided to respectively accommodate such treatment means for treating water flowing through such channels. These water treatment means are applied to modify water fed to the water treatment unit 20 and impart various properties, which influence plant growth, to the water to produce modified water. The modified water may then be fed to the main reactor 40 to produce a final solution of the nutrition formula for plants.

In one embodiment, the nutrition elements received and held in the plurality of nutrition units 30 include microelements, macroelements, biologically active additives and bacteria. If desired, nano-elements may be additionally included.

The microelements received and hold in the nutrition units 30 include one or more of Co, Mn, Cu, Fe, Ag, I, Mo, V, Se, Zn, Li, B, Ni, F.

The macroelements received and hold in the nutrition units 30 include one or more of P, Ca, K, C, Mg, Na, and S.

In one embodiment, the plurality of gas supply units 50 include nine (9) gas supply units, which respectively receive and hold therein CO₂, O₂, O₃, H₂, NO, N₂, C₂H₄, H₂S and other kinds of gases.

In one embodiment, the liquid storage unit 60 has at least four containers, which respectively receive and hold therein at least three different nutrition solution formulas and the filtered, purified and modified water supplied from the water treatment unit 20. The at least three different nutrition solution formulas are fed to the three growth boxes 71, 72, 73.

In one embodiment, the controlling elements of each of the growth boxes 71, 72, 73 include a plurality of light sources 91, a light source 92, a plurality of fans 93, an air-conditioning device (a heater and/or a cooler) 94, a speaker 95, a UV light source 96, gas exhaust means 972, gas input means 981, a magnetic ring 982, a stein heater 983, an electric unit 984, and a vibration unit 985. The light source 92 is configured on one side wall of each of the growth boxes 71, 72, 73. The gas input means 981, the magnetic ring 982, the stein heater 983, the electric unit 984, and the vibration unit 985 are arranged close to a plant that grows in each of the growth boxes 71, 72, 73.

The speaker 95 plays music that promotes the growth of a plant inside the growth boxes 71, 72, 73.

The light source 92 is formed of light-emitting diodes (LED) that are selectively set up as sources of infrared light (IR), ultraviolet light (UV) and visible light having adjustable or preset properties, including light intensity, color, wavelength, and the likes.

The magnetic ring 982 is arranged outside and around a stein of a stein inside the growth boxes 71, 72, 73 and may also be arranged around a plant root or leave. In an alternative arrangement, additional magnetic rings may be used for different parts of a plant.

The electric unit 984 supplies an electric current to a plant inside the growth boxes 71, 72, 73.

The vibration unit 985 is operable to vibrate a plant inside the growth boxes 71, 72, 73 in order to stimulate the growth of the plant.

In one embodiment, the growth boxes 71, 72, 73 include a plurality of monitoring units 991 and a plurality of sensors 9921, 9922. The sensor 9921 is arranged to detect a stein of a plant inside the growth boxes 71, 72, 73, and the sensor 9922 detect the roots of the plant. The sensors 9921, 9922 each have a built-in processing unit (CPU) and software, which compares and determines whether data of detection, such as environmental factors of the growth boxes 71, 72, 73 detected by the sensors 9921, 9922 match preset values set up by the user. The CPUs and software of the sensors 9921, 9922 issue a command to start the controlling elements to make the environmental factors inside the growth boxes 71, 72, 73 meet the preset values.

The sensor 9921 may detect chlorophyll, the amount of gas, temperature, humidity, brightness, and the likes.

The sensor 9922 may detect temperature, humidity, ammonia (NH4+), redox value (ORP), nitrate (NO3-), nitrites (NO2-), dissolved oxygen, weight, liquid height detector (level sensor), PH value, turbidity, and the likes.

In one embodiment, the system 1 further includes a filtering unit 993 in connection with the growth boxes 71, 72, 73, the liquid storage unit 60, and the water supply units 10. The filtering unit 993 functions to filter liquid drained out of the growth boxes 71, 72, 73 and the liquid storage unit 60 to provide filtered liquid that flows back to the water supply units 10 for recycling.

In one embodiment, the at least three growth boxes 71, 72, 73 are arranged in a vertical direction for cultivation of short plants.

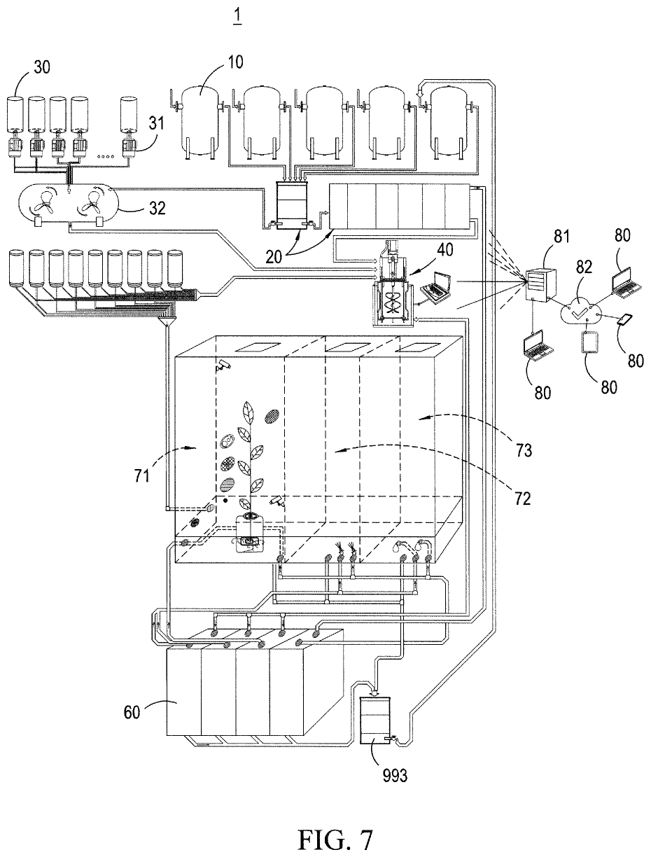

Referring to FIG. 7, in an alternative example, the at least three growth boxes 71, 72, 73 are arranged in a horizontal direction for cultivation of tall plants.

A method is also provided for selection of an optimal plant cultivation process. The method includes the following steps:

(a) providing a plurality of participants with a cultivation system capable of selecting an optimal cultivation method for carrying out a plant cultivation competition;

(b) establishing the eligibility of the plant cultivation competition;

(c) establishing a growing process in the plant cultivation competition, the growing process being aeroponics, drip irrigation or hydroponics;

(d) establishing types of plants in the plant cultivation competition;

(e) combining the growing processes with the plant types so as to carry out a variety of plant cultivation competitions, in which the participants choose the growing processes and the plant types;

(f) announcing competition starting date and a participant registration period through media, so that all participants finish registration and pay an access fee on the website;

(g) providing all participants with required seedlings and one incubator containing at least three growing boxes 71, 72, 73; allowing the participants to cultivate seedlings with three different conditions or using three different growth formulas at the same time, which gives more chances to succeed;

(h) adjusting and controlling plant growing conditions, growing methods and nutrition formula in the growth boxes 71, 72, 73 by the participants by selecting a plurality of controlling elements, cultivation units and reactor 40 provided by the plant cultivation system 1 of the optimal plant cultivation method;

(i) choosing the best growing box out of three and submitting it to selection committee by participants after the competition finishes, the committee selecting the best growing method and nutrition formula, thereby finding out the best cultivation methods of the plants; and

(j) selecting the best plant cultivation method according to the kinds of the plants, and judging and rating the specifications of the kinds of the plants.

Referring to FIG. 7, a participant in any corner of the world may use the information device 80 to connect with the servo control unit 81 in a wired or wireless transmission way so as to control the control action of the reactor 40 and the operation of the controlling elements of the growth boxes 71, 72, 73 through the control software, programs and commands preset by the servo control unit 81.

Accordingly, the present invention may control plant growth factors and nutrient supply of the growth boxes 71, 72, 73 remotely, the remote control being acted at least as the following:

(1) selecting the dosing and mixing of liquid nutrients;

(2) choosing water and water regulation;

(3) choosing the mixing of gas and nutrient;

(4) preparing the final formulation of nutrient liquid in the reactor 40;

(5) controlling the growth factors of plant roots;

(6) controlling the growth factors of plant stems; and

(7) archiving and analyzing plant growth process statistical data.

The present invention has the following advantages:

(A) a new platform for remote research, especially for those who cannot conduct their own research and experiments on the growth of plants in required and necessary test conditions;

(B) the participants in every place of the world can operate the same greenhouse facilities together at the same time, and grow the same plant or a several types of plants at the same time, latitude and location. But, every participant themselves may use the facilities provided in the greenhouse to adjust and control other growing conditions, cultivation methods and nutrition formulas, and the best cultivation method and nutrition formula are selected, thereby finding out the best cultivation method of the plant when the competition is over;

(C) people all over the world and even in outer space can use the cultivation facilities of the present invention to study, test the cultivation methods and nutrition formulas of the plants only through internet;

(D) the participants in any place of the world can use the cultivation facilities of the present invention to simulate experimental cultivations such as a variety of temperatures, humidity, soil textures, gases, pHs, sunlight, and then select the one having the best effect among a variety of experimental cultivation methods and formulas, which is used for formal cultivation use in the future so that the participants may only stay at home or a work place to carry out experiments simply through internet with no need of a long journey to specific fields and laboratories and does not have to build laboratories by themselves. In addition, the same plant can be grown by means of a variety of methods at the same time, the experimental cost and time decreased substantially, and uncertain factors (e.g. place-to-place four seasons temperature, temperature and humidity, soil, pH value, air quality difference, sunshine difference) reduced significantly the experiments so carried out can obtain the best cultivation method and nutrition formula for each kind of plant.

(E) the research results can be used immediately on greenhouse agriculture, commercialized directly; the installation of the same facilities all over the world to culture plants will not be restrained and affected by local climate difference.

(F) in traditional cultivation, people need work actually in the field such that they must be strong. But, people with disabilities can even carry out plant cultivation and much more research an optimal plant cultivation methods and formulas only by controlling a computer or mobile device with network.

The present invention further provides a turnkey platform for cybernetic control of plant growth from preparing a growth medium to growing plants through remote control. This functions as “a smart factory for plant growth”.

In such a cybernetic control platform, a user may set up numerous conditions for growing plants as desired and receives a finished product with pre-planned characteristics, for examples:

(1) for diabetics: plants with a minimum sugar content;

(2) for patients with hemoglobin deficiency: plants with a high iron content;

(3) for patients with heart diseases: plants with a high content of potassium and magnesium; and

(4) for strengthening the immune system: plants with a high content of vitamin C and other vitamins.

In this platform, the content of chemicals and nutrients in a plant and its individual organs may be properly managed so as to turn the plant into biological additives for proper nutrition and health promotion with defined functions.

According to the present invention, the smart plant factory includes two main units, one being a unit for preparation of a growth medium and the other being a plant growing unit, which is a phytotron or a plant incubator. The phytotron or incubator may be referred back to the previous description concerning the growth boxes 71, 72, 73 shown in for example FIG. 1. For such a purpose, the phytotron or incubator may also refer to a growth box or a growing box, of which certain details have been provided above, while additional specifics may be known from the following description.

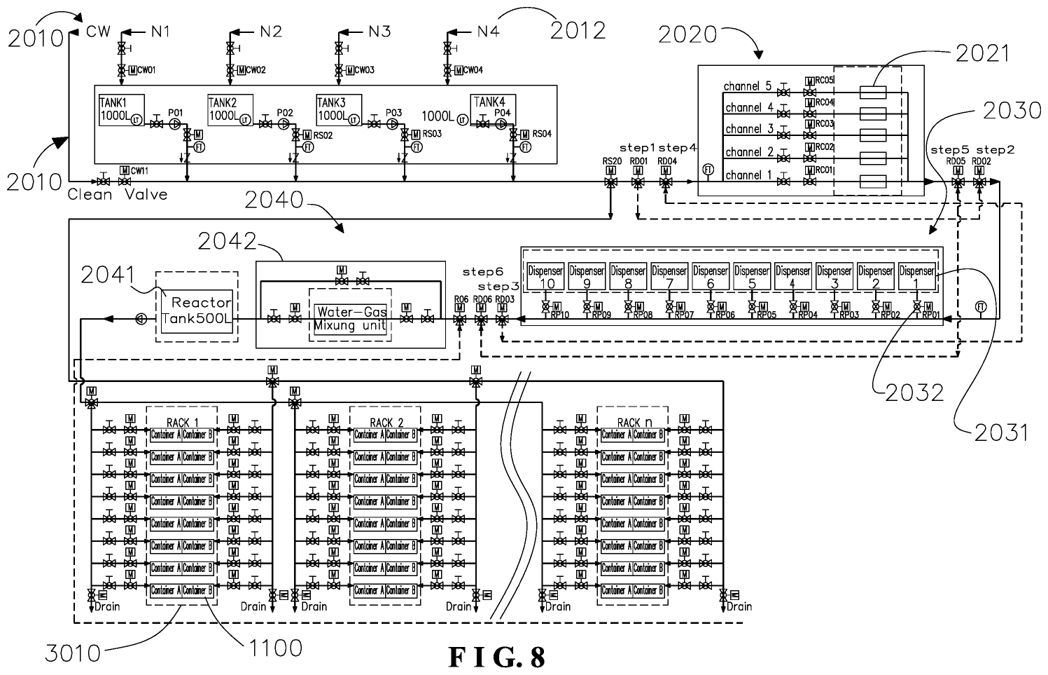

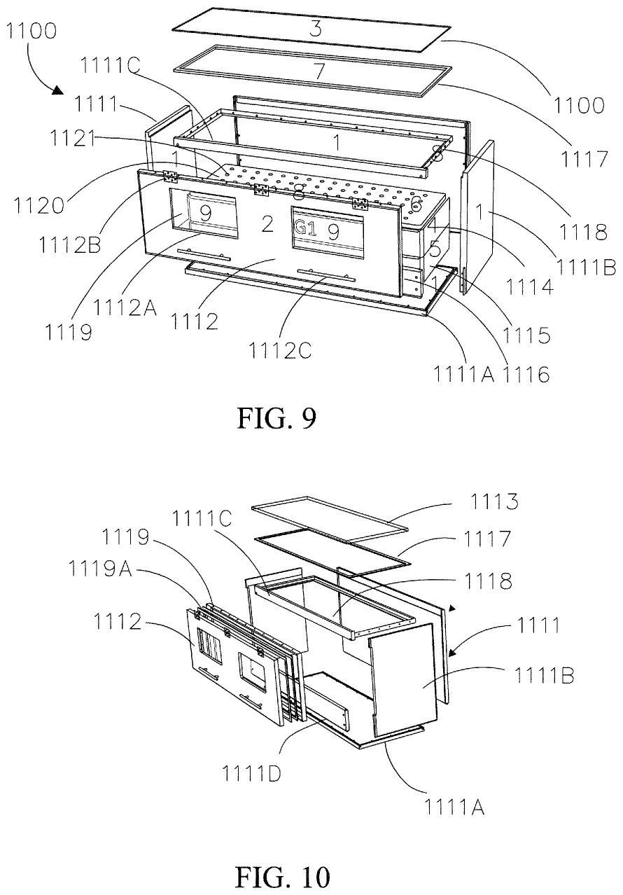

A more detailed description of the cybernetic control platform will be provided below with reference to FIGS. 8 and 9.

Firstly, the first part of the smart plant factory, namely the unit for preparation of a growth medium for plants, which will also be referred to as a growth medium preparation unit, includes sub-systems for plant growth control factors, including water, water structure, nano-elements, gases, and growth medium parameters.

For the factors of water and water structure, reference is made back to FIG. 1 for the water supply units 10 and the water treatment unit 20. In a preferred embodiment shown in FIG. 8, a water supply module 2010 is provided, and the water supply module comprises multiple water supply units, which are designated at 2012 in FIG. 8, but may be of an arrangement and structure similar to the water supply units 10 presented with the previous embodiment and shown in FIG. 1. Multiple types of water are supplied respectively through the multiple water supply units, such that each of the multiple water supply units provides a separate, predetermined type or source of water, which is fed, as a combined source of water through for example a pipeline sub-system 2011, and is used to prepare the growth medium. Such separate sources of water may include city water (tap water), rainwater with preliminary treatment, distilled water, and water with control of the deuterium content in water 1-150 PPM, or those described above.

The above types of water may be subjected to treatment, such as those carried out in the water treatment unit 20 of FIG. 1 in order to make a desired water structure. In the embodiment shown in FIG. 8, a five channel based water treatment unit 2020 is shown, including five treatment channels 2021 through which water flows to be subjected to different types of water treatment in the channels 2021.

In a preferred embodiment, seven treatment channels are included in the water treatment unit, which are respectively referred to first to seventh channels and will be discussed below. It is noted that the present invention is not limited any specific number for the water treatment channels. For example, the seven treatment channels are arranged as a combination of the five channels shown in FIG. 8 and two extra channels not shown in FIG. 8.

The first channel allows water to be treated with a magnetic field by creating a magnetic field of controlled intensity around for example a tube or a pipe that constitute the channel. Such a tube or pipe will be referred to as a channel tube.

The second channel allows water to be treated with an electric field by creating an electric field of controlled intensity around the channel tubes.

The third channel allows to process water with vibration by using a device that creates a vibration with adjustable parameters.

The fourth channel allows to create cavitation in the water passing through the tube.

The fifth channel allows both heating and water cooling due to an induction heater in the first half of the pipe and a cooler in the second half of the pipe.

The sixth channel allows magnetic treatment of water by passing water through a set of disc magnets.

The seventh channel allows water treatment with ultrasound of adjustable frequency and intensity.

The platform further includes a nutrition module 2030 that includes a dosing or dispensing system that may include one or more or all of the nutrition units 30 of FIG. 1, or simply constitutes a part of the nutrition unit 30 or may be even an expanded form of the nutrition unit 30. In the embodiment shown in FIG. 8, the nutrition module 2030 comprises ten sources of nutrition 2031. However, this invention is limited to any specific number of sources of nutrition.

The dosing system of the nutrition module 2030 functions to add preset components from the sources of nutrition to water from the combined source of water. The dosing system is operable to select desired nano-, micro- and macro elements in a required amount from 0.001 milliliters. The sizes of nano-, micro-, and macro elements are selected for mixing with water, such as 5, 25, 50, 75, 100, 150, 200, 300, 400, 500. The dosing system of the nutrition module 2030 may include a device as an option for additional components such as amino acids, microorganisms, protective equipment and more. In the embodiment shown in FIG. 8, the sources of nutrition include a supply of elements, in the form of nano-, micro- and macro elements, and optionally a supply of the additional components, to the water.

As a preferred example, the nutrition module 2030 is connected to the pipeline sub-system 2011 at a location downstream of the water treatment module 202, and these sources of nutrition are added into the water after the water is subjected to water treatment carried out in the water treatment module 2020. As shown in FIG. 8, the sources of nutrition 2031 are each connected through a vale 2032 to the pipeline sub-system 2011 downstream of the water treatment module 2020 in order to realize a controlled supply of such nutrition to the treated water.

Various gases may be supplied in this platform. The supply of various gases is referred to back to the gas supply units 50 of FIG. 1. Further details are provided below. Desired types of gases and concentrations are selected and supplied to a reactor sub-system 2040, which will be discussed hereinafter, to be mixed with water. In an embodiment, nine types of gas are selectively supplied. In a preferred alternative, a process of selecting among the nine gases is carried out with software. This is for the safety of working with such gases. In this way, certain restrictions may be imposed on proportion and concentration of each of the gases to be mixed, as this is controlled by software having preset criteria.

The reactor sub-system 2040 includes a reactor 2041 and a mixing unit 2042. The reactor 40 shown in FIG. 1 may be provided in this platform as the reactor of the reactor sub-system 2040 for the purposes of selecting and mixing growth medium ingredients. The mixing unit are operable to carry out a process of mixing water with the nano-components and the gases discussed above. The reactor 2041 is operable to allow a user to select and set time, pressure, temperature, P/H, electrical conductivity. After the preparation of the growth medium, the growth medium, which makes a formula for plant grown and may be in the form of liquid, is automatically fed into a tank, which is located in the lower part of the phytotron or growing box for its further use in growing plants. Details of the phytotron or growing box will be provided below.

In this way, the preparation of the growth medium, or the growth medium itself, show excellent property of repeatability. The formula of this growth medium as a recipe for plant nutrition may be stored in the archive. Further, the user has the opportunity to automatically create a variety of nutrient solution formulas for a variety of plant nutrition recipes.

As an alternative example, FIG. 8 provides an illustration of an arrangement for the system, which is different from what shown in FIG. 1, yet constructed of similar components.

The second part of the smart plant factory, namely the phytotron or the incubator or the growth box, a group of multiple growth boxes (or simply the boxes) may be used. In the example shown in FIG. 8, multiple growth boxes are arranged on multiple racks 3010. Each of the racks 3010 carries a number of the growth boxes 1100 that are connected to the pipeline sub-system 2011 in order to receive the water that is fed out of the reactor sub-system 2040.

The boxes 1100 are included in this platform for growing plants and, as noted in the previous examples, the boxes are divided into two types, one for short plants and the other for tall plants.

For easy illustration, only one of the growth boxes or phytotrons will be described as an example, and the remaining ones, if any, would be structured in a similar form having a similar arrangement, with or without minor modifications.

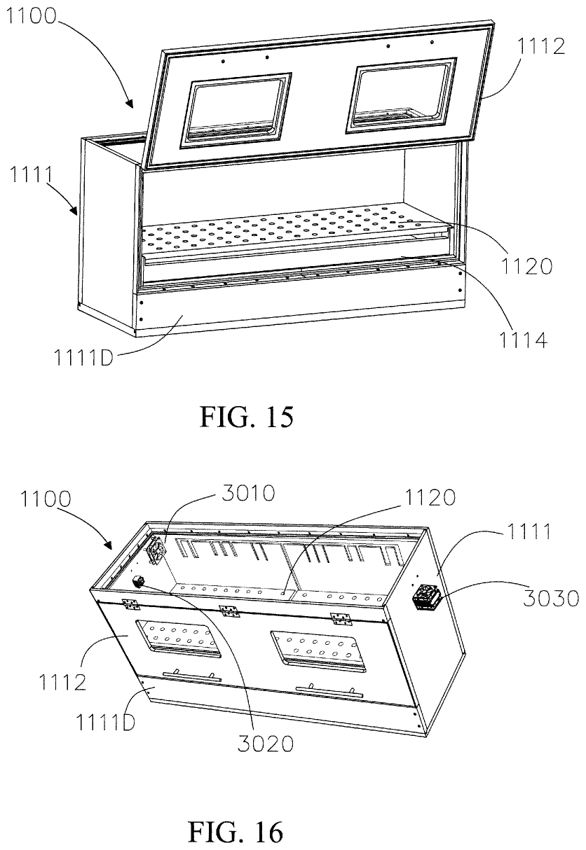

FIG. 9 provides an example of the box, which is generally designated at 1100, of which a perspective view showing the box 1100 in an assembled form is provided in FIGS. 14 and 15, respectively illustrating a closed condition and an open condition.

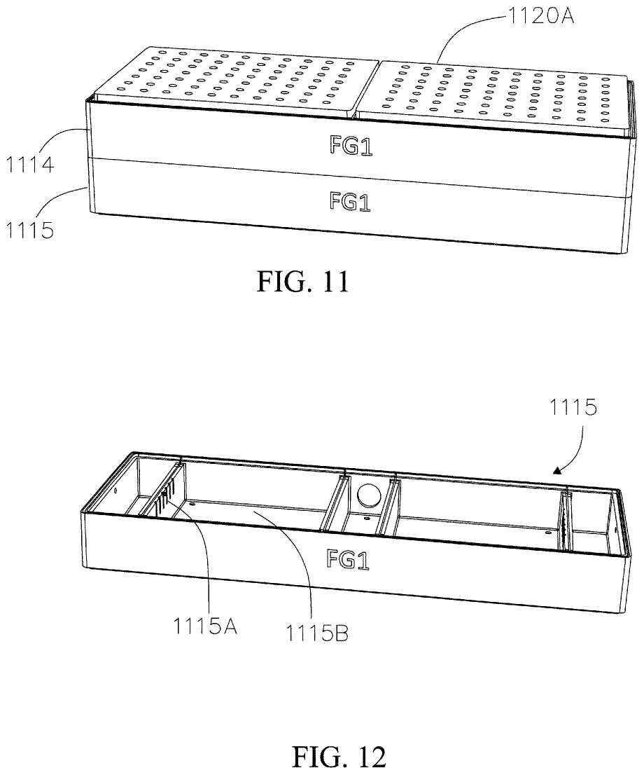

The box 1100 includes two tanks, an upper tank 1114 and a lower tank 1115 (also see FIG. 11) located on a lower part of an interior space thereof and supported by a base or bottom 111A. The upper tank 1114 is preferably stacked atop the lower tank 1115, see FIG. 11. A clearer view of each of the two tanks 1114, 1115 is provided in FIG. 12. For illustration only, the lower tank 1115 is provided in FIG. 12; however, the upper tank 1114 may just has a similar structure.

The lower tank 1115 has an interior space, which is preferably divided by partitions 1115A into multiple compartments 111B having therein a void space, see FIG. 12, for receiving and storing therein two or more types of growth media, clean water, equipment for cooling and box control controller (not shown) in such spaces.

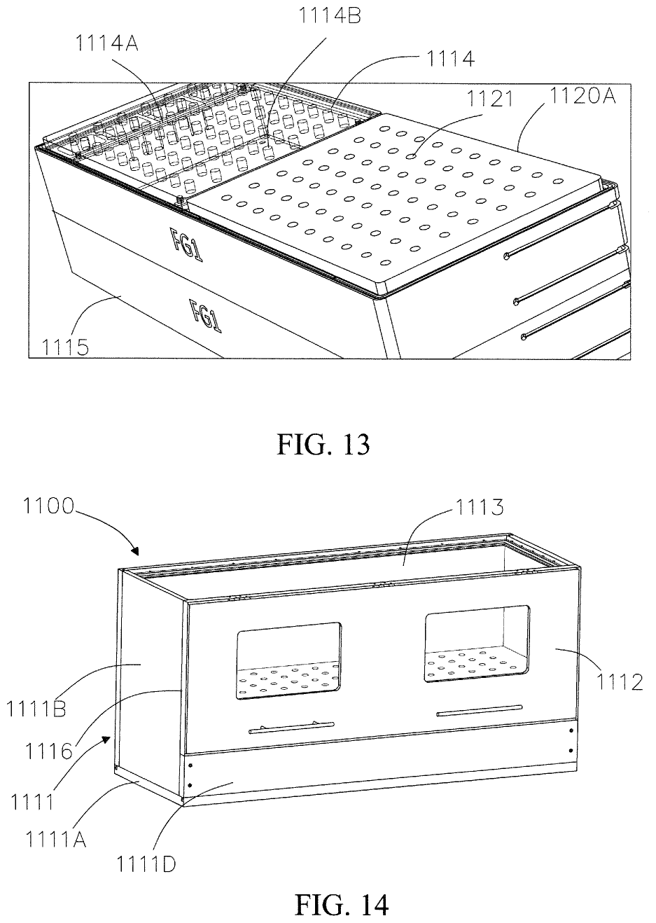

The upper tank 1114 may similarly have an interior space, but selectively and preferably not divided into separate compartments, which is for growing the root part of plants (not shown). However, if desired, the upper tank 1114 may be optionally provided with compartments 1114A to define separate compartments 1114B, as provided in an alternative example shown in FIG. 13.

The two tanks 1114, 1115 occupy the lower part of the box 1100 and supported on the base or bottom 1111A of the box 1100. The box 1100 also has a void space in an upper part thereof that is above the two tanks 1114, 1115. The void space of the upper part of the box 1100 is intended for the growth of a stein part of a plant or multiple plants.

The box 1100 and the two tanks 1114, 1115 are made of a foam material in order to maintain a stable temperature in the interior space of the box and the tanks.

As noted above, the two tanks 1114, 1115 have similar configurations. The difference is only in the absence of partitions 1115B in the upper tank 1102 for the growth of the root part of the plants. This configuration provides an easy way for the nutrient solution to circulate between the lower and upper tanks 1114, 1115 with minimum of energy for raising water. This configuration allows to maintain the temperature of the nutrient solution.

Referring back to FIG. 9, the box 1100 comprises nine main parts, which will be separately described below.

The box 1100 includes a box body 1111, as a first main part, defining a closed or sealed chamber or container. The box body 1111 includes the base or bottom 1111A. The base or bottom 1111A is made of a heat-insulating material. In the example illustrated, the box body 1111 has a front opening for access of the interior thereof.

The box 1100 includes, as a second main part, a box door 1112 that is made of a heat-insulating material and has one or more transparent inner windows 1112A for visual observation of the interior of the box 1110. Two such windows 1112A are provided in the example, and are preferably openings formed in the box door 1112. The box door 1112 is preferably made openable, such as mounted to the box body 1111 or an additional component, such as an aluminum profile 1116 (to be described hereinafter) combined with the box body 1111 by means of hinges 1112B, so that the box door 1112 is openable, through rotation relative to the box body 1111, or closable to close the front opening of the box body 1111.

The box door 1112 may be provided, on a front surface thereof, with a handle 1112C for hand holding to open the box door 1112.

The box body 1111 also has a top that forms an opening and a top transparent plate 1113, preferably a glass plate, which is the third part of the box 1100, is set on a top of the box body 1111 and cover and close the top opening of the box body 1111. The top glass plate 1113 that is set at the top of the box body 1111 of the box 1100 is made of highly diffuse glass with a vacuum interlayer (not shown). A glass plate with a vacuum interlayer is commonly known and no further detail will be necessary.

The upper tank 1114, which is a fourth main part of the box 1100, is made of a foamed insulating material and, as noted above, may be provided, as an example, for accommodating the root part of the plant.

The lower tank 1115, which is a fifth main part of the box 1100, is also made of a foamed insulating material and as noted above, may be provided for accommodating the plant growth medium.

The aluminum profile 1116, which, as a sixth main part of the box 1110, includes or in combined with corner parts, is arranged as a frame that is combined with the box body 1111 to cover the front opening of the box body and to receive the box door 1112 to be hinged thereto.

In addition, as a seventh main part of the box 1110, a rubber pad 1117 is provided under the glass plate 1113 and is supported between the glass plate 1113 and the top of the box body 1111 to ensure air tightness of the box 1100 at the top thereof.

As an eight main part, an aluminum corner 1118 that is in the form of a frame is mounted to the top opening of the box body 1111 for supporting the glass plate 1113 at the top of the box 1100. The rubber pad 1117 is interposed between the glass plate 1113 and the aluminum corner 1118 to provide air-tight engagement therebetween.

It is noted that although both the aluminum profile 1116 and the aluminum corner 1118 are described as being made of “aluminum”, the materials that can be used to make the profile 1116 and the corner 1118 are not limited to aluminum. Any material that provide sufficient strength for the purposes that the profile 1116 and the corner 1118 should serve could be used to made the profile 1116 and the corner 1118.

Each of the openings 1112A of the box door 1112 is covered with a transparent plate 1119, which is a ninth main part of the box 1100. In the example illustrated, the transparent plate 1119 is made of transparent acrylic. Other materials, such as glass, may also be used for such a transparent plate 1119.

As shown in FIG. 10, the transparent plate 1119 is of a size that corresponds to the box door 1112 and is attached to an inner side of the box door 1112 with one or more sealing gaskets 1119A interposed therebetween.

It is noted that the upper tank 1114 and the lower tank 1115 are removed from FIG. 10 for simplifying the illustration.

In the example illustrated, in addition to the base or bottom 1111A, the box body 1111 also includes multiple sidewalls 1111B that are connected to each other and to the base or bottom 1111A to define the front opening and the top opening of the box body 1111.

The sidewalls 111B are preferably provided with a step in each of the sidewalls 111B at a location close to the top opening of the box body 1111 in order to support the corner 1118 thereon.

Atop connection member 1111C is provided to span between upper ends of two opposite ones of the sidewalls 1111B of the box body 1111 in order to provide as a covering for the corner 118, preferably being attached to the corner 1118, or may be selectively connected to the two sidewalls 111B to provide a desired structural strength or to provide for easy mounting of the hinges 1112B of the box door 1112.

A bottom connection member 111D (also see FIG. 10) is provided to connect between, as spanning between, lower ends of the two opposite sidewalls 1111B of the box body 1111 in order to provide a desired structural strength for the box door 1112, or other purposes.

It is noted, as provided in an alternative example shown in FIGS. 14 and 15, the top connection member 1111C may be omitted, while the bottom connection member 1111D is preserved for structural strength.

In the example shown in FIG. 9, a plant plate 1120 is provided atop the upper tank 1114. The plant plate 11120 is formed with an array of openings 1121, preferably arranged an array including multiple rows and multiple columns. The plant plate 1120 may be made in one piece, as shown in FIG. 9, having a size sufficiently to cover the top of the upper tank 1114. Or, alternatively, two separate plant plates 1120A, also formed with the openings 1121, are provided to collectively cover the top of the upper tank 1114. In other words, each of the plant plates 1120A covers a part of the top of the upper tank 1114, and a combination of the two plant plates 1120A, as being arranged side by side, would sufficient to cover the top of the upper tank 1114. This arrangement allows each of two plant plates 1120A to be removed individually to expose the interior space of the upper tank 1114.

The openings 1121 are arranged to extend, preferably in a direction perpendicular to a surface of the plant plate 1120, 1120A, completely through the plant plate 1120, 1120A, to each support one plant therein with a root of the plant (not shown) extending in to the interior space of the upper tank 1114 in which the nutrition solution is held, so that the root may absorb the nutrition from the solution held in the upper tank 1114.

A clearer view showing the opening 1121 extending completely through the plant plate 1120, 1120A is provided in FIG. 13.

Referring to FIGS. 11-13, the upper tank 1114 and the lower tank 1115 are preferably of the same size having the same height, the same width, and the same length, as each being of a parallelepiped configuration and, preferably and as shown, being a rectangular cuboid.

Further, as shown in FIGS. 9, 15, and 16, the upper part of the box 1100, which is a void space for accommodating stems of plants, has a height selected for plant growth, and such a height of the upper part of the box 11100 is preferably equal to the sum of the heights of the two tanks 1114, 1115.

As noted above with reference to the previous embodiments, the plant growth box can be of two types, one being a tall box and the other being a short box.

In a further example shown in FIG. 16, various operation devices and/sensors are provided in the box body 1111 and preferably mounted at suitable locations, such as the sidewalls 1111B. In the example illustrated in FIG. 16, a fan 3010, an LED light 3020, and a ventilator 3030, are mounted to sidewalls 1111B of the box body 1111. It is appreciated that other devices and/or sensors as those described with reference to the previous embodiment and FIG. 6 may be selectively incorporated in the growing box 1100, if desired.

For a short box, which is provided for growing short plants, as described above, the height of the upper part of the box 1100 is the same as the combined height of the upper and lower tanks 1114, 1115.

For a tall box, which is provided for growing tall plants or plants requiring additional space, the height of the upper part of the box 1100 can be as large as five times the combined height of the two tanks 1114, 1115. However, no specific constraint is made for the height of the upper part of the box 1100, whether it is a short box or a tall box.

Similar to the examples of growth boxes 71, 72, 73 provided in for example FIG. 6, the box or phytotrons 1100, whether a short one or a tall one, can be provided with sensors and equipment, of which an example is shown in FIG. 16, for the purpose of or additionally incorporating measures for automatic remote control.

In a way similar to what disclosed in FIGS. 6 and 7, the box or phytotron 1100 of the smart plant factory incorporate automatically control plant growth factors that enable settings of different parameters for plant growth. Details are provided below. It is noted that certain details can be found in the previous embodiment shown in FIGS. 1-7.

### Factor #1—Temperature Management and Control of the Nutrient Solution in the Tanks of the Box

To control and maintain water temperature, equipment based on a Peltier semiconductor element and a tube system is used. The user can control the intensity of the semiconductor cooling through the current control in the Peltier element. A system of closed tubes filled with a special liquid touches the Peltier plate and the liquid in them is cooled to the temperature of the semiconductor. The tubes cover the bottom of the nutrient solution tank and the nutrient solution is cooled to the temperature of the tubes with liquid.

### Factor #2—Management and Control of the Supply of Nutrient Solution to the Root Part of the Plant

The user can set the on and off time of a pump. The user can set the duration of the pump run time. The user can also select the type of pump. The nutrient solution can be supplied through two types of low and high pressure pumps. The low pressure pumps are used for drip irrigation and hydroponic systems. High pressure pumps are used for the aeroponics system. (The drip irrigation, hydroponic, and aeroponics systems have been discussed above with reference to the previous embodiments.)

### Factor #3—Management and Control of the Parameters of the Nutrient Solution

The user can set and change the parameters of electrical conductivity and P/H of nutrient solution, which is located in the lower tank. The system of sensors that is located in the nutrient solution provides the user with information about these parameters.

If the sensor indicators differ from the set parameters by the user during preliminary preparation of the nutrient medium in the reactor, the user is able to automatically send the nutrient medium to the reactor again and change the parameters of the nutrient solution to the desired ones.

### Factor #4—Moisture Control in the Growth Tank of the Root Part of the Plant

The user has a humidity sensor and when the humidity drops below normal, the water mist supply system is turned on.

Water is automatically supplied from the lower tank and sprayed into the tank for the root of the plant through nozzles. If the humidity level is higher than normal, the fan is turned on to draw out moist air and supply the air with lower humidity to the tank from the outside.

### Factor #5—Control of the UV and UVC Lamp in the Growth Tank of the Root Part of Plants

The lamp has two types of LEDs with UV and UVC spectra. The user can choose the type of light, its duration and the on and off time.

### Factor #6—Control of the Electrophoresis Process in the Root of the Plant

The user can select the time for turning on the electricity, its duration and its current strength

### Factor #7—Management and Control of Passage of the Nutrient Solution in the Form of a Liquid in the Root Part

When a hydroponics system is selected, the user selects the time for switching on the low-pressure pump to supply the nutrient solution and its time spent in the tank as well as its rhythm of switching on.

Factor #8—Management and Control of Passage of the Nutrient Solution in the Form of Fog in the Root Part

When an aeroponics system is selected, the user selects the time for switching on the high-pressure pump to supply the nutrient solution to the tanks through the spraying system with high-pressure nozzles in the form of steam, selecting the rhythm of switching on and the duration of steam supply.

### Factor #9—Selection and Supply of Gases to the Root Part of the Plant

When an aeroponics system is selected, the user has the opportunity to select the gas, its concentration and volume for supplying to the root part of the plant. The user can control the start time of the supply, duration and rhythm of the supply.

### Factor #10—Ability to Automatically Select a Growth Medium

The user can automatically select a growth medium for use in the root of the plant from a first or a second compartment of the upper tank.

### Factor #11—Ability to Automatically Replace the Growth Medium in One of the Compartments of the Upper Tank

The user has the ability to automatically drain the unnecessary growth medium from one of the compartments of the lower tank. After that, the user can prepare a new growth medium for the full technological cycle of preparation and pour it into the tank compartment again.

### Factor #12—Control of the Temperature in the Box of the Stem Part of Plant (Decreasing the Temperature)

The user can set the desired temperature in the box at different periods of the day, month, or year. Temperature sensors are used to measure temperature.

To control and maintain air temperature, equipment based on Peltier semiconductor and a fan on one side of the box are used, see FIG. 16. The user can control the cooling of the semiconductor radiator inside the box through the control of the current passing through the Peltier element.

The second radiator, which heats up, is located on the outside of the box. A fan is attached to the semiconductor radiator, which carries the cooled air throughout the box.

### Factor #13—Control of the Temperature in the Box of the Stem Part of Plant Increasing the Temperature)

The user can set the desired temperature in the box at different periods of the day, month, or year. Temperature sensors are used to measure temperature. To control and maintain air temperature, equipment based on Peltier semiconductor and a fan on one side of the box are used, see FIG. 16.

The user can control the heating of the semiconductor radiator inside the box through the control of the current passing through the Peltier element.

The second radiator, which cools down, is located on the outside of the box. A fan is attached to the semiconductor radiator, which carries the cooled air throughout the box.

### Factor #14—Control of Temperature Increase in the Lower Part of the Stem

The user can set the desired temperature at different periods of the day, month, or year. Sensors are used to measure temperature.

To control the temperature of the air around the bottom of the stem, a film that is attached to the top of the plate is used. The plate separates the root and stem parts of the plant.

A special film with carbon fibers covers the entire plate and has holes for stems. When current is passed through carbon filaments, which are located in a circle around the hole, the film is heated.

At the same time, the bottom of the plant and the top of the plant have different temperatures, which are regulated by the user through control of the amount of current passing through the carbon filaments.

### Factor #15—Humidity Control in the Stein Part of Plants

The user sets the desired value of humidity, the time of setting humidity, the duration of its maintenance.

There are two humidity sensors in the box to measure the humidity level. When the humidity is low, the controller automatically turns on the water mist to balance the humidity with the parameters set by the user. At high humidity, the controller turns on the air cooler without turning on the internal fan. At the same time, on the opposite side of the box, the controller turns on the heating of the air through another Peltier semiconductor with a fan. This is necessary to compensate for the drop in air temperature.

Due to the fact that the temperature of the cooling plate becomes lower than the air temperature, dew appears on it and then flows into the lower tank as drops of water.

After reaching the desired humidity, the controller turns off the function of lowering the humidity and balances all the specified parameters by the user in the box with the stein part of the plant.

### Factor #16—Control and Management of the Spectrum of Lighting Inside the Box

The design of the box is made so that the LED lighting lamp is located outside the plant growth box. The upper part of the box is made of special diffuse glass with a vacuum interlayer to maintain a stable temperature in the box.

The light stream from the LED lamp passes through the glass, but due to the special design of the glass, the heat generated by the LEDs goes outside of the plant growth box.

Flat LED luminaire consists of three identical LED-lamps with a size of 500×500 mm. The lamp is made in the form of a thin aluminum plate onto which LED chips are applied with different wavelengths from 300 to 800 nanometers.

The radiation wavelengths of LED chips correspond to different peaks in the spectrum of sunlight. The design of the LED chips is such that the chips of each wavelength differ in the angle of illumination and illuminate a surface measuring 600×600 mm.

Three LED lamps cover an area of 1800×600 mm.

In total, there are 36 types of LED chips on the plate, combined into 36 groups that differ in the wavelength of light.

The placement design is made so that the inclusion of any of the 36 groups covers an area of 600×600 mm They are placed in a way that if any of the 36-groups is turned on, it covers an area of 600×600 mm.

The software allows to set 256 shades of color for each of the 36 groups of LED chips.

Thus, the user has the opportunity to choose different combinations of the light spectrum based on the available 36 groups of LED chips and select one of 256 shades of the glow of each group.

This allows the user to have many options for a wide variety of combinations and have an archive to control their use.

The user can also use the software to set the desired combination of lighting and its operating time during the day, month, or year.

### Factor #17—Control and Brightness Management of Lighting Inside the Box

Through the voltage changes the user can set the desired brightness of the LED lamp and its operating time. An optical sensor is provided at the top of the box. The user can set the brightness of the lighting in the box at a distance from the lamp to the plant. When the plant grows and approaches the lamp, the optical sensor will inform the controller about this and the controller will reduce the lamp brightness so that the specified amount of light is constantly at the top of the plant.

### Factor #18—Control and Management of the Gas Atmosphere Inside the Box

To control and manage the atmosphere inside the box, the user can use nine gases: CO₂, O₂, O₃, H₂, NO, N₂, C₂H₄, H₂S.

In the box there are 9 sensors that provide information on the concentration of gases. The box has a completely sealed design, which allows to provide and keep the desired composition of the atmosphere inside.

Before using gases, the user selects the required gases and their concentration through the control interface.

There are restrictions on the concentration and combination of gases in the software for safety requirements.

In the box, there is a gas discharge system through the automatic opening of the valve when the pressure level is exceeded or when the types of gases are replaced by the user.

To maintain an accurate gas concentration, a system of 9 gas sensors and a gas meter is provided.

### Factor #19—Control and Analysis of Plant Growth by its Weight

One of the important indicators of plant growth is weight gain. For these purposes, eight sensors are installed under the plant growth plate on the tank of the root part of the plan, which weigh each minute. Based on the data received from the sensors and available software, a diagram is formed throughout the entire process of plant growth.

### Factor #20—Control Factors and Analysis of Plant Growth by Indicators of the Chlorophyll Process in Leaves

Measuring the chlorophyll content gives an indicator of photosynthetic activity related to the concentration of nitrogen in the sample. It is especially important to carry out these measurements in plant growth programs, if necessary, carefully monitor the effects of nitrogen addition to the crop and other applied factors. A special integrated clip for the leaf allows instant measurements that do not damage the leaves. The received information in real time allows the user to monitor the health of the photosynthesis system inside the sheet, taking into account the application of various factors.

### Factor #21—the Factor of Soil Condition Monitoring by Drip Nutrition.

An important factor for monitoring the soil and its condition is its electrical conductivity.

The EC measures the soil's ability to conduct electric current using salt properties to conduct it, so the EC measures the concentration of soluble salts present in the soil solution. The higher the value, the easier it is for a specified current to pass through the same soil through a higher salt concentration. This factor is important for studies on the influence of salts and their concentrations on the electrical conductivity of the soil and the effect of its level of conductivity on plant growth.

### Factor #22—the Factor of Music

On two sides of the plant growth box, two speakers are located. The user has the opportunity to play different music, melodies, songs, sounds of different frequencies and more through the speaker, using the software to control it. The user can choose the type, power, start time, end and duration of the experiment.

### Factor #23—the Vibration Factor

The lateral part of the plant growth plate is equipped with a mechanism creating that creates a vibration with an amplitude of 0-60 Hertz with an impact amplitude of 0.5-1 mm.

This factor allows you to control the development of the stein and root system of plants by using vibration. Under the action of a drive, for example, an eccentric mechanism, it makes a linear horizontal reciprocating motion and thereby creates a kinematic vibrational disturbance on the plate and thereby on the plants that are on this plate and on the root part.

The user has the ability to set the amplitude of the vibration, its beginning and end as well as its duration.

### Factor #24—Pressure Factor

The box for growing plants has a design that controls tightness. The box can withstand fluctuations in internal pressures plus/minus 30% from 760 mmHg. Art. in the GHS system and is equivalent to 1.01325 bar or 101 325 Pa in the International System of Units (SI).

In the box, there is a pressure sensor that displays data of pressure in the box. The user can set the pressure in the aisles to plus/minus 30%, and control the set pressure parameters in the box through the air injection compressor and the vacuum compressor.

This factor is important for conducting a study of plant growth in different countries of the world, taking into account the specific pressure in each region.

### Factor #25—Factor of Accounting and Analysis

Factor of accounting and analysis is the archive and library of user research. The user can also use a common archival database, where the user can use different factors and their parameters for the research.

I claim:

1. A plant growing system, comprising a growth medium preparation unit and a plant growing unit,
wherein the growth medium preparation unit comprises:
a water supply module that comprises at least one water supply unit, which supplies a source of water through a pipeline sub-system;
a water treatment unit that is connected to the water supply module through the pipeline sub-system to receive water from the source of water, the water treatment unit comprising at least one channel in which predetermined treatment is applied to the water;
a nutrition module that is connected to the pipeline sub-system and comprises at least one nutrition unit, which supplies, through a dosing system, an element in the form of one of a nano-element, a micro-element, and a macro-element to, the water from the source of water;
a reactor sub-system that is connected to the pipeline sub-system and includes a mixing unit for mixing at least one type of gas from a gas supply source in the water supplied through the pipeline sub-system and includes the element supplied from the nutrition module added therein; and a reactor that receives the water supplied through the pipeline sub-system to flow therethrough and is operable for selection among a plurality of growth medium parameters applied to the water to provide a modified type of water that carries a nutrition formula according to the treatment applied to the water from the source of water and the gas and the element introduced into the water; and
wherein the plant growing unit is connected to the pipeline sub-system to receive the modified type of water through the pipeline sub-system, the plant growing unit comprising multiple growth boxes that are connected to the pipeline sub-system, each of the growing boxes comprising:
a box body having an interior space defined by sidewalls and a base to form a closed chamber;
a lower tank and an upper tank received in the interior space of the box body and stacked in sequence on the base to occupy a lower part of the chamber of the box body, an upper part of the chamber being a void space, wherein the upper tank has an interior space into which the modified type of water that carries the nutrition formula is fed, such that a predetermined amount of the modified type of water is held in the interior space of the upper tank; and
at least one plant plate, which is disposed on a top of the upper tank and covers at least a part of an opening formed in the top of the upper tank, wherein the at least one plant plate is formed with a least one opening extending completely through the at least one plant plate and adapted to hold a plant therein such that a root of the plant is located in the interior space of the upper tank and a stein of plant is located above the at least one plant plate and in the void space of the upper part of the chamber of the box body.

2. The plant growing system according to claim 1, wherein the box body has a front opening, a box door being openably attached to the box body to selectively close the front opening.

3. The plant growing system according to claim 2, wherein the box door comprises at least one window and the at least one window is covered by a transparent plate.

4. The plant growing system according to claim 2, wherein the box door is openably attached to the box body by means of at least one hinge.

5. The plant growing system according to claim 2, wherein a frame is attached to the front opening of the box body and the box door is attached, in an openable manner, to the frame to selectively close the front opening of the box body.

6. The plant growing system according to claim 1, wherein the box body has a top that is formed with a top opening, the top opening being closed by a top transparent plate.

7. The plant growing system according to claim 6, wherein the top transparent plate comprises a glass plate made of a piece of highly diffuse glass including a vacuum interlayer.

8. The plant growing system according to claim 6, wherein a rubber pad is interposed between the top of the box body and the top transparent plate.

9. The plant growing system according to claim 6, wherein a frame is mounted to the top opening of the box body to support top transparent plate on the top of the box body.

10. The plant growing system according to claim 9, wherein a rubber pad is interposed between the frame mounted to the top opening of the box body and the top transparent plate.

11. The plant growing system according to claim 1, wherein the lower tank and the upper tank have a combined height and the upper part of the interior space of the closed chamber of the box body has a height that is identical to the combined height of the lower and upper tanks.

12. The plant growing system according to claim 1, wherein the lower tank and the upper tank have a combined height and the upper part of the interior space of the closed chamber of the box body has a height that is greater than the combined height of the lower and upper tanks.

13. The plant growing system according to claim 11, wherein the height of the upper part of the interior space of the closed chamber of the box body is five times of the combined height of the lower and upper tanks.

14. The plant growing system according to claim 1, wherein the at least one plant plate comprises a single-piece plate that completely covers the opening of the top of the upper tank.

15. The plant growing system according to claim 1, wherein the at least one plant plate comprises two plates that are arranged side on side to cover, at least partly, the opening of the top of the upper tank.

16. The plant growing system according to claim 1, wherein the upper tank includes at least one partition mounted in the interior space thereof to divide the interior space into multiple compartments.

17. The plant growing system according to claim 1, wherein at least one light is mounted to the sidewalls of the box body.

18. The plant growing system according to claim 1, wherein at least one fan is mounted to the sidewalls of the box body.

19. The plant growing system according to claim 1, wherein at least one ventilation device is mounted to the sidewalls of the box body.

20. The plant growing system according to claim 1, wherein the dosing system additionally comprises a device for selectively supplying an additional component of at least one of amino acids, microorganisms, protective equipment to the water from the source of water.

21. The plant growing system according to claim 1, wherein the water treatment unit comprises multiple treatment channels through which the water from the source of water flows, wherein the water flowing through each of the treatment channels is subjected treatment of one of a magnetic field, an electric field, vibration, cavitation forming in the water, heating and cooling at separate parts of the channel, flowing through magnets, and ultrasonic wave treatment.
